(19) United States
(12) Patent Application Publication
(10) Pub. No.: US 2022/0408233 A1
(43) Pub. Date: Dec. 22, 2022

(54) INTERNET OF THINGS (IOT) WATER PRESSURE AND QUALITY MONITORING SYSTEM

(71) Applicant: Nobel Systems, Redlands, CA (US)

(72) Inventors: Michael Samuel, Redlands, CA (US); Tanmay THAKUR, Redlands, CA (US)

(21) Appl. No.: 17/837,033

(22) Filed: Jun. 10, 2022

Related U.S. Application Data
(60) Provisional application No. 63/211,566, filed on Jun. 17, 2021.

(51) Int. Cl. H04W 4/38; G16Y 40/10; G16Y 40/40

(52) U.S. Cl. CPC H04W 4/38; G16Y 40/10; G16Y 40/40

(57) ABSTRACT

A water pressure and quality sensing system for use in a municipal water supply. The system includes a pressure transducer in fluid communication with the municipal water supply, the pressure transducer configured to convert fluid pressure to an analog electrical signal. A network modem including firmware configured to interpret the analog electrical signal is provided, the network modem is in electrical communication with the pressure transducer. The network modem configured to communicate wirelessly with a device remote manager. The device remote manager having an application programming interface (API) and a geographic information system (GIS) software platform configured for analyzing incoming data with a geoviewer functionality, wherein the geoviewer functionality is configured for generating pipeline leak alerts.

### RELATED APPLICATIONS

This application claims priority to U.S. Patent Application Ser. No. 63/211,566, “Internet of Things (IoT) Water Pressure and Quality Monitoring System,” which was filed on Jun. 17, 2021, and is incorporated here by reference in its entirety.

### BACKGROUND

### Field of the Invention

The present invention generally relates to water monitoring. More specifically, the present invention relates to an Internet of Things (IoT) based method of water monitoring and management.

### Related Art

Pipeline failures and unpredictable leaks for water companies is a worldwide issue with consequences including loss of revenue, infrastructure, and environmental concerns. To mitigate this issue, we have developed a system that helps prevents frequent water leaks and reduce non-revenue water loss. Disclosed is a successfully implemented system using Internet of things technology to address pressure and quality issues with municipal drinking water as currently known in the art.

### SUMMARY

A water pressure and quality sensing system for use in a municipal water supply includes a pressure transducer in fluid communication with the municipal water supply. The pressure transducer is configured to convert fluid pressure to an analog electrical signal. A network modem which includes firmware configured to interpret the analog electrical signal is also provided. The network modem is in electrical communication with the pressure transducer, and the network modem is configured to communicate wirelessly with a device remote manager.

The device remote manager includes an application programming interface (API) and a geographic information system (GIS) software platform configured for analyzing incoming data with a geoviewer functionality. The geoviewer functionality is configured for generating pipeline leak alerts and alerts regarding water quality.

In various implementations, the geoviewer functionality may be further configured for preventative maintenance scheduling. The modem may be in electrical communication with a solar panel thereby enabling remote operation. The modem may also be an Internet of Things (IoT) modem configured to run on an IoT bandwidth.

In other implementations, the application programming interface is configured to produce a pressure value versus errors chart based on pressure values from the pressure transducer. The firmware may be configured with parameters chosen from the list of oversampling rate, high alarm threshold, low alarm threshold, scaled pressure range, sensor description, enable analog 0-5 volts interface, read sensor frequency, transmit data frequency, and analog power output.

The modem may operate on the long-term evolution (LTE) standard, category M1, low-power wide area network, on a frequency band of B4 (1700 MHz) and B13 (700 MHz). Alternatively, the modem may operate on the long-term evolution (LTE) standard, category M1, low-power wide area network, on a frequency band 28 (700 MHz) and a frequency band 5 (850 MHz). Preferably, the modem is programmed with an access point name (APN).

In yet other implementations, the pressure transducer has an ingress protection rating of IP67. The API and GIS may be configured to allow the setting of pressure thresholds for alerts. Additionally, the API and GIS may be configured to provide a usage chart and map of an installation area. Additionally, the API and GIS may be configured for monitoring multiple installation locations simultaneously. The API and GIS may also be configured with a supervisory control and data acquisition (SCADA) system.

In other implementations, in addition to the water pressure functionality, the system may include a water quality monitoring meter device. The water quality monitoring device may measure total dissolved solvents (TDS). The TDS measurements may be in a parts per million (ppm) range of 10 ppm to 2500 ppm. Additionally, the TDS measurements may be based on conductivity converted into a 4-20 milliamp signal and may be conducted over time. Preferably, the water pressure measurements of the pressure transducer, and the TDS measurements for water quality are combined in the API and GIS thereby providing visual representations of pressure and quality.

### BRIEF DESCRIPTION OF THE FIGURES

FIG. 1 illustrates an architectural block diagram of a water monitoring and management system.

FIG. 2 illustrates a graph of the pressure to voltage ratio of a pressure transducer of the water monitoring and management system.

FIG. 3 illustrates a pressure value versus errors chart reflecting values established by an Internet of Things (IoT) cellular gateway.

FIG. 4 illustrates the pressure transducer installed in a water system air release valve.

FIG. 5 illustrates a complete custom enclosure of the air release valve including a solar panel.

FIG. 6 illustrates an installation of the pressure transducer at a water system meter ten feet underground.

FIG. 7 illustrates a location being monitored with data analysis including a usage chart and map of the installation area.

FIG. 8 illustrates a chart showing several locations being monitored at the same time.

FIG. 9 illustrates a chart of pressure monitored over time, including a maximum, minimum, and average psi.

FIG. 10 illustrates a one-month data correlation chart of a 4-20 ma signal for total dissolved solvents (TDS).

FIG. 11 illustrates TDS levels at a water district tank.

FIG. 12 illustrates a TDS probe installed in a twenty-six-inch main line of a potable water supply.

FIG. 13 illustrates the TDS system installed in a housing with a power supply.

FIG. 14 illustrates a chart of water quality data from the TDS system plotted over time.

FIG. 15 illustrates measured water psi over time, including a maximum, minimum and average psi.

### REFERENCE NUMBERS

10. pressure transducer
12. network modem
14. solar panel
16. firmware
18. device remote manager
20. API integration
22. GIS software platform
24. leak alert
26. pressure fluctuation
28. voltage value
30. output voltage
32. linear regression
34. deviation
36. air release valve
38. custom enclosure
40. water system meter
42. usage chart
44. map
46. monitored locations
48. maximum psi
50. minimum psi
52. average psi
54. main line
56. water quality data

### DESCRIPTION

The following description is presented to enable any person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the principles and features disclosed herein.

The system of the present disclosure monitors pressures in remote locations, without the need for electricity or a wireless (e.g., Wi-Fi) network. This system monitors pressure fluctuations and pressure transients to detect water pipeline leaks. Below is the architectural block diagram system. In one implementation, the system is integrated and configured to monitor pressures ranging from 0 psi to 400 psi, while the data collection frequency can be adjusted in a range of every 30 seconds to every 1 hour. In another implementation, the data cloud transfer frequency can be in a range of every 15 minutes to every 2 hours. The integrated system helps users build ready-to-install pressure monitoring devices.

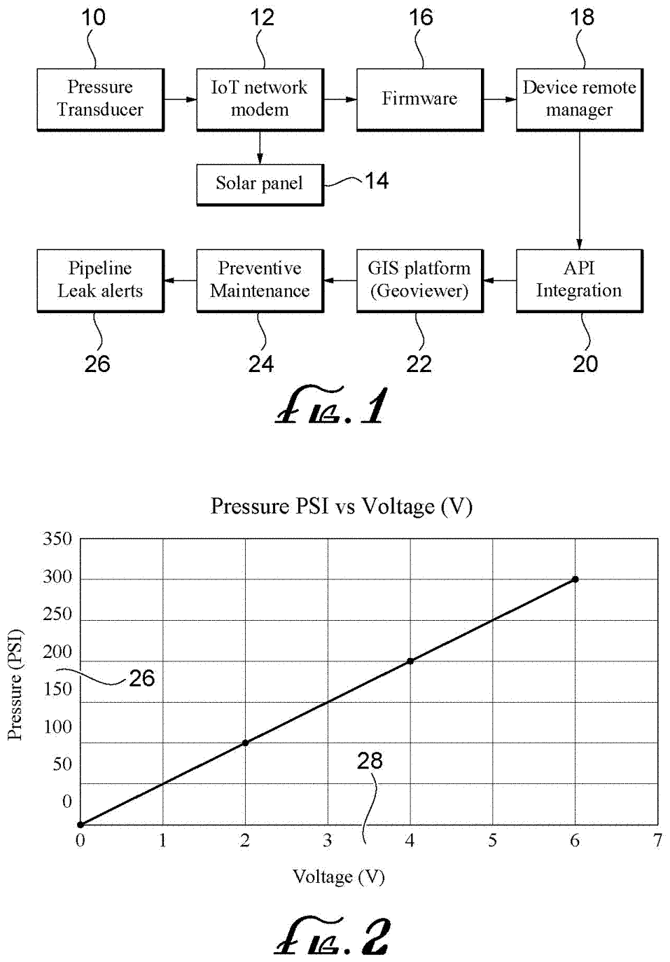

FIG. 1 shows a block architectural diagram of all elements of the system. A pressure transducer 10 is provided which converts fluid pressure to an analog electrical signal. The electrical signal from the pressure transducer 10 is communicated to an Internet of Things (IoT) network modem 12. The modem 12 may be in electrical communication with a solar panel 14 for remote/continuous operation. A firmware 16 associated with the IoT network modem 12 is included, with the firmware 16 and a device remote manager 18 comprising an IoT cellular gateway. An application programing interface (API) integration 20 and a geographic information system (GIS) software platform 22 are provided to analyze incoming data, with the GIS platform including a Geoviewer for capturing, storing, and checking geographic data related to the information. Using the interpolated geographical data, a preventative maintenance module 24 including scheduling functionality, can be implemented, including generating pipeline leak alerts 24 through a variety of outputs.

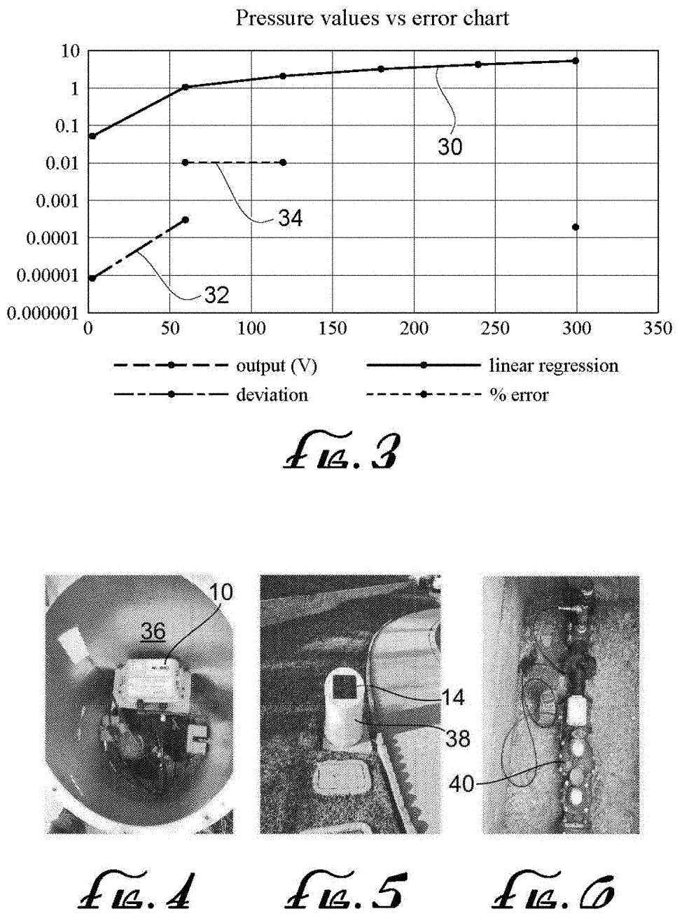

FIG. 2 illustrates a graph of the pressure (in psi) to voltage ratio of the pressure transducer 10 (FIG. 1). As discussed above, the pressure transducer 10 can convert pressure fluctuations to analog values. Typically, these values can be either 4-20 ma or 0-5 volts. Known IoT systems can auto-calibrate to scale these current (ma) or voltage changes to represent them as pressure values. As illustrated, there is a linear relationship observed between the pressure fluctuations 26 and the voltage (or current) values 28. For example, 100 psi fluid pressure yields 2 volts, 200 psi fluid pressure yields 4 volts, and 300 psi fluid pressure yields 6 volts, etc.

FIG. 3 illustrates a pressure value vs. errors chart reflecting values established by the IoT cellular gateway comprising the IoT modem 12 firmware 16, and device remote manager 18. The values include output voltage 30, linear regression 32, deviation 34, and will generate a percentage error according to those values. The IoT cellular gateway (IoT modem 12, firmware 16, and device remote manager 18) may be battery powered and is programmed with a custom firmware 16 (i.e., the firmware 16 in the IoT modem 12 is customized for specific installation requirements). The firmware 16 code and configuration files preferably address the following parameters: oversampling rate, high alarm threshold, low alarm threshold, scaled pressure range, sensor description, enable analog 0-5 volts interface, read sensor frequency, transmit data frequency, and analog power output.

Wirelessly, the cellular gateway works on the long-term evolution (LTE) standard, category M1 (cat M1) low-power wide area network (LPWAN) on a frequency band of B4 (1700 MHz) and B13 (700 MHz). An IoT enabler, in one implementation, TELIT® modem integration, allows the system to connect to the LTE cat M1 network. For implementations in the Philippines, these devices are also used for LTE cat M1 connections at frequency band 28 (700 MHz) and frequency band 5 (850 MHz). The IoT cellular modem 12 is programmed with an access point name (APN) from a cellular provider (for example, wyleslte.gw7.vzwentp). In one implementation, the pressure transducer 10 (FIG. 1) is powered with a 15-volt supply from the IoT modem 12 battery.

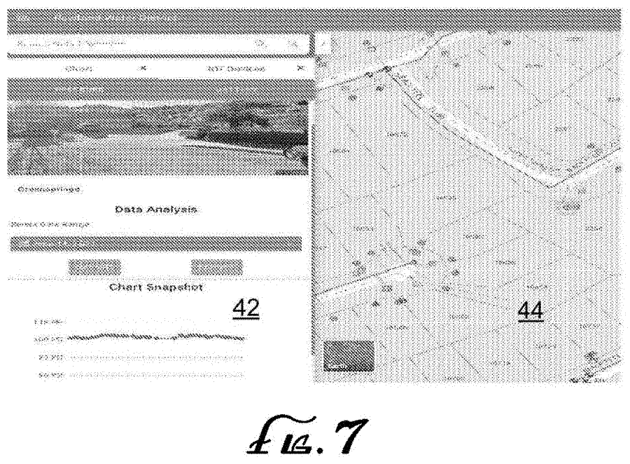

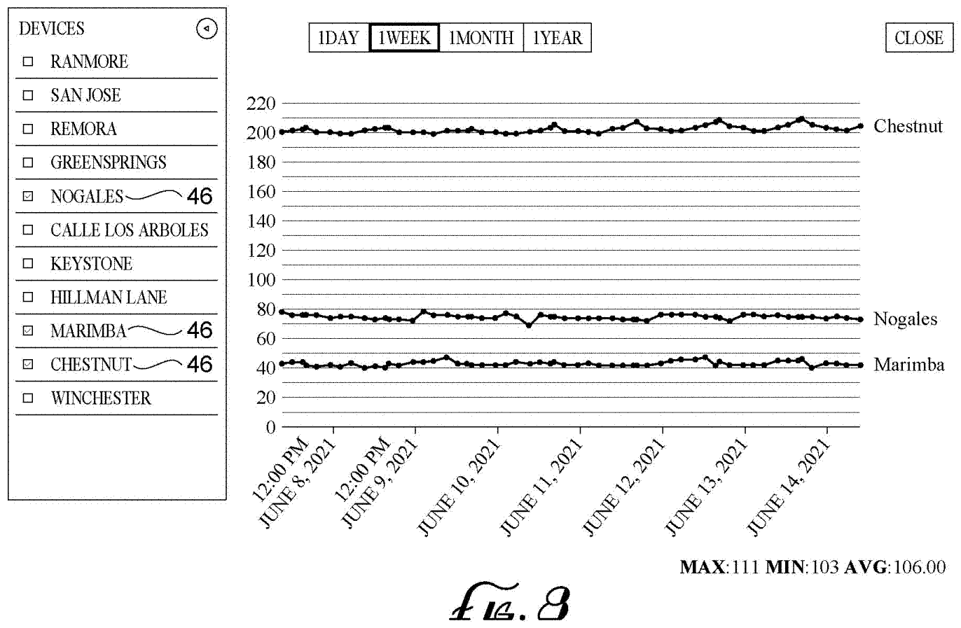

Referring to FIGS. 4, 5, and 6, several possible installations of the pressure transducer 10 are shown. The pressure transducers 10 (and optionally, modem 12) are ingress protection (IP) rated, preferably having an IP67 rating. Thus, protection against contact with objects greater than 1 mm in diameter is provided, along with protection against short periods of immersion in water while under a pressure between 15 cm and 1 m. FIG. 4 illustrates the pressure transducer 10 installed inside a water system air release valve 36. FIG. 5 illustrates a complete custom enclosure 38 of the air release valve 36, including a solar panel 14. FIG. 6 illustrates an installation of the pressure transducer 10 at a water system meter 40 ten feet underground.

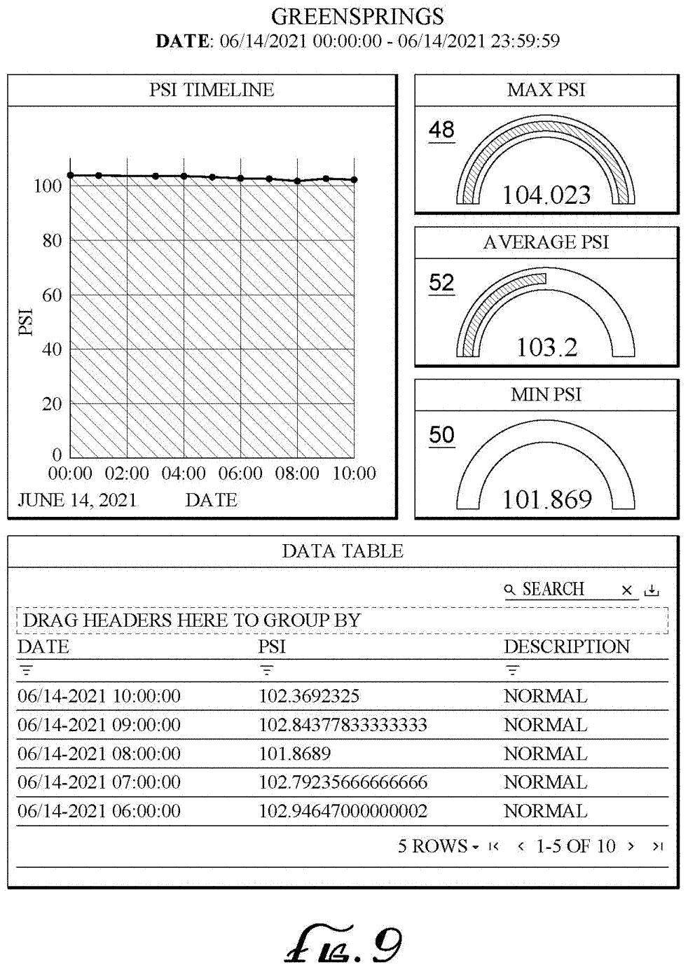

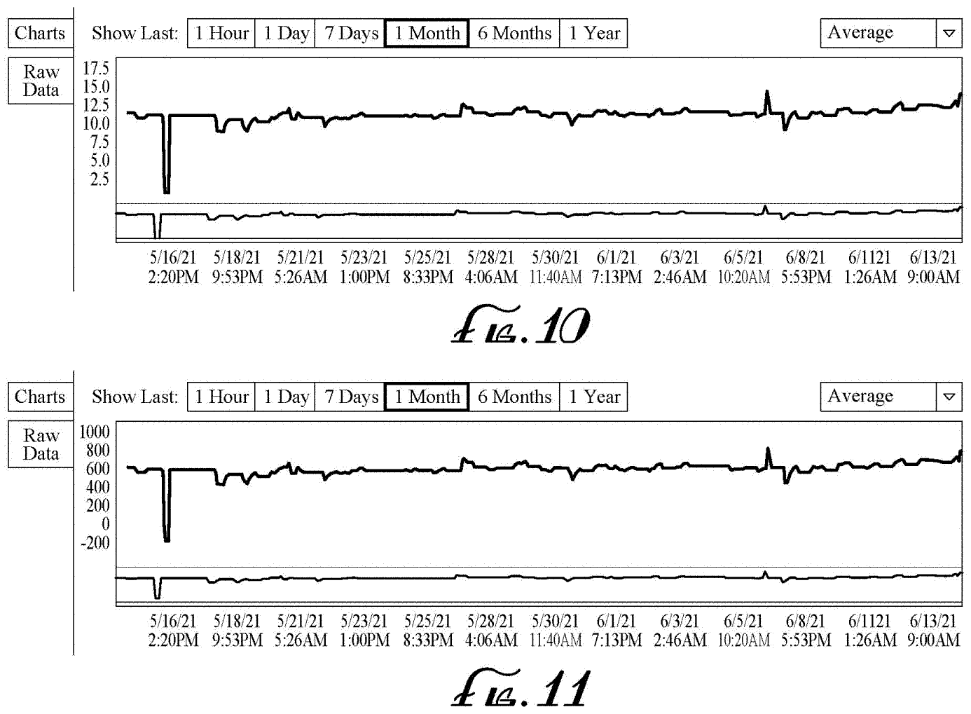

Referring to FIGS. 7, 8, and 9, exemplary implementations of the application programming interface (API) integration 20 and GIS software platform 22 are shown. The analog data from the pressure transducer 10 is converted into pressure fluctuation 26 values and transferred to a digital management cloud platform (not shown). This stored data is retrieved in a systems cloud database and in one implementation, represented on the GIS software platform 22 (FIG. 1) platform. Using the API integration 18 and a graphic information system viewer 20, a user has the capability to analyze the data and set pressure thresholds for alerts. FIG. 7 illustrates a location being monitored with data analysis including a usage chart 42 and a map 44 of the installation area. FIG. 8 illustrates several locations 46 being monitored at the same time. FIG. 9 illustrates pressure monitored over time including a maximum measured psi 48, a minimum measured psi 50 and a psi average 52.

Referring to the leak alert 24 (FIG. 1) functions/apparatus, in one implementation a supervisory control and data acquisition (SCADA) system is used. Preferably, secured SCADA servers are deployed in utility systems without the need for any programmable logic controller (PLC) devices. Thus, battery-powered devices transfer data to secured SCADA servers. The method using a middleware software designated open automation software which converts the data to an open platform communications (OPC) server protocol. The data is updated in real-time as soon as the information is transferred to a server (i.e., the “cloud”) by the pressure transducer 10 and any related devices. This SCADA systems integration helps a utility company analyze water pressure data at a remote location with very minimal infrastructure. The utility can also receive low and high-pressure alerts on the SACDA system (including via a text and/or call) using a custom method.

The water quality monitoring aspects of the present disclosure include measuring total dissolved solvents (TDS). The TDS level helps indicate whether drinking water is fit for consumption, requires filtration, or is highly contaminated. Parts per million (PPM) is the measurement used for measuring TDS in potable water. The present system helps a utility monitor these TDS levels remotely in real-time to enable the utility to provide save drinking to a community. The TDS meter device indicates water quality based on its PPM readings, and in any installation, has been tested for any water quality changes which range from 10 ppm to 2500 ppm values. The water quality aspect of the system provides real-time alerts so that preventive measures can be taken as soon as possible before the water quality worsens in any given instance. The system can be set to a required threshold PPM value to trigger, generate and receive alerts. The real-time monitoring of the ppm levels for water can be as low as every 5 seconds depending on the requirements and situations.

In one implementation, PPM levels are observed using a TDS probe in a controlled environment and patterns are plotted. A strong correlation is observed between the PPM levels and impurities such as salt, dust, and metals, which have a very strong impact on the conductivity of the probe. This conductivity is converted into a 4-20 ma signal. It has been observed that the 4-20 ma signal linearly changes with the TDS levels. Therefore, the raw 4-20 ma values are converted into TDS ranges and integrated with the above described Geoviewer GIS platform for customer visualization.

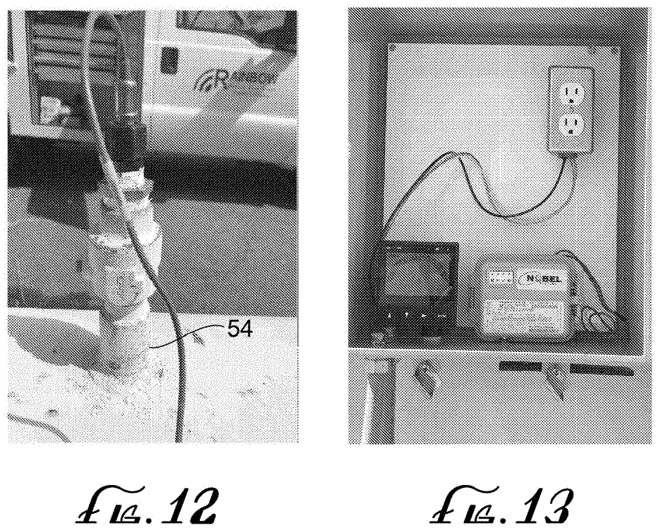

FIG. 10 illustrates a one-month data correlation of the 4-20 ma signal and the actual TDS levels at a utility water tank, and FIG. 11 illustrates TDS levels at the water district tank in question. This system is installed at several locations in the utility water tanks. A probe inserted into the pipeline outlet of a tank and to a cellular system reads the incoming current signal to transmit it to a remote server (i.e., the “cloud”).

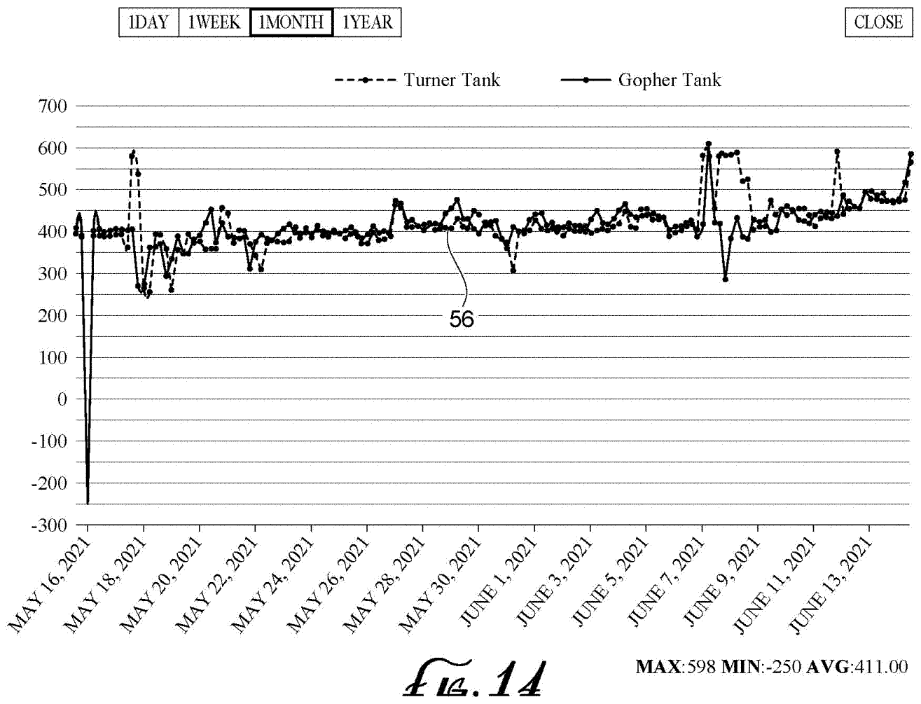

FIGS. 12 and 13 illustrate installation of the TDS monitoring portion of the system. In FIG. 12, the TDS probe is installed in a twenty-six-inch main line 54 connected to a potable water tank (not shown) and supplying community water. The system's remote connectivity discussed above is applied to the TDS probe. FIG. 13 show the system installed in a housing with a power supply.

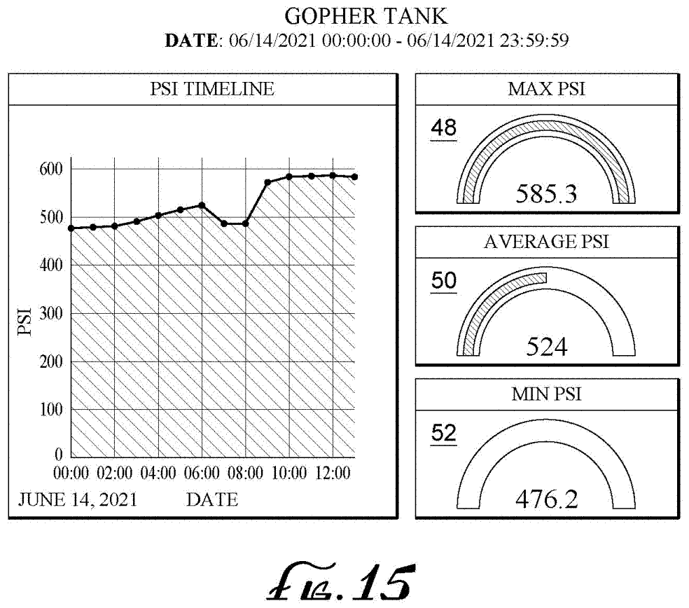

Referring to FIGS. 14 and 15, the TDS water quality monitoring data is shown as viewed on a Geoviewer platform which also indicates water pressure. FIG. 14 illustrates water quality data 42 plotted over time. FIG. 14 illustrates water pressure data 56 monitored over time. FIG. 15 illustrates measured water psi over time, including a maximum measured psi 48, a minimum measured psi 50 and a psi average 52. This water quality information is used by the water districts as well as the local farmers to use water in their farmers for better crop yields.

The foregoing descriptions of embodiments of the present disclosure have been presented only for purposes of illustration and description. They are not intended to be exhaustive or to limit the present disclosure to the forms disclosed. Accordingly, many modifications and variations will be apparent to practitioners skilled in the art. Additionally, the above disclosure is not intended to limit the present invention. The scope of the present disclosure is defined by the appended claims.

What is claimed is:

1. A water pressure and quality sensing system for use in a municipal water supply, the system comprising:
a pressure transducer in fluid communication with the municipal water supply, the pressure transducer configured to convert fluid pressure to an analog electrical signal;
a network modem comprising firmware configured to interpret the analog electrical signal, the network modem in electrical communication with the pressure transducer, the network modem configured to communicate wirelessly with a device remote manager;
the device remote manager having an application programming interface (API) and a geographic information system (GIS) software platform configured for analyzing incoming data with a geoviewer functionality; and
wherein the geoviewer functionality is configured for generating pipeline leak alerts.

2. The system of claim 1 wherein the geoviewer functionality is further configured for preventative maintenance scheduling.

3. The system of claim 1 wherein the modem is in electrical communication with a solar panel thereby enabling remote operation.

4. The system of claim 1 wherein the modem is an Internet of Things (IoT) modem configured to run on an IoT bandwidth.

5. The system of claim 1 wherein the application programming interface is configured to produce a pressure value versus errors chart based on pressure values from the pressure transducer.

6. The system of claim 1 wherein the firmware is configured with parameters chosen from the list of oversampling rate, high alarm threshold, low alarm threshold, scaled pressure range, sensor description, enable analog 0-5 volts interface, read sensor frequency, transmit data frequency, and analog power output.

7. The system of claim 1 wherein the modem operates on the long-term evolution (LTE) standard, category M1, low-power wide area network, on a frequency band of B4 (1700 MHz) and B13 (700 MHz).

8. The system of claim 1 wherein the modem operates on the long-term evolution (LTE) standard, category M1, low-power wide area network, on a frequency band 28 (700 MHz) and a frequency band 5 (850 MHz).

9. The system of claim 1 wherein the modem is programmed with an access point name (APN).

10. The system of claim 1 wherein the pressure transducer has an ingress protection rating of IP67.

11. The system of claim 1 wherein the API and GIS are configured to allow the setting of pressure thresholds for alerts.

12. The system of claim 1 wherein the API and GIS are configured to provide a usage chart and map of an installation area.

13. The system of claim 1 wherein the API and GIS are configured for monitoring multiple installation locations simultaneously.

14. The system of claim 1 wherein the API and GIS are configured with a supervisory control and data acquisition (SCADA) system.

15. The system of claim 1 further comprising a water quality monitoring meter device.

16. The system of claim 15 wherein the water quality monitoring device measures total dissolved solvents (TDS).

17. The system of claim 16 wherein the TDS measurements are in a parts per million (ppm) range of 10 ppm to 2500 ppm.

18. The system of claim 16 wherein the TDS measurements are based on conductivity converted into a 4-20 milliamp signal.

19. The system of claim 16, wherein the TDS measurements are conducted over time.

20. The system of claim 19 wherein the water pressure measurements of the pressure transducer, and the TDS measurements for water quality are combined in the API and GIS thereby providing visual representations of pressure and quality.
